(19) United States
(12) Patent Application Publication
(10) Pub. No.: US 2015/0061483 A1
(43) Pub. Date: Mar. 5, 2015

(54) CABINET DRAWER ASSEMBLY HAVING A DRAWER LOCKING DEVICE

(71) Applicant: Chia-Ming LIU, Dou-Lio City, Yun-Lin County (TW)

(72) Inventor: Chia-Ming LIU, Dou-Lio City, Yun-Lin County (TW)

(21) Appl. No.: 14/109,245

(22) Filed: Dec. 17, 2013

(30) Foreign Application Priority Data
Aug. 27, 2013 (CN) 201320528150.0

(51) Int. Cl. A47B 88/04; A47B 95/02; E05B 65/46

(52) U.S. Cl. CPC A47B 88/04; E05B 65/46; A47B 95/02
USPC 312/332.1

(57) ABSTRACT

A drawer assembly is disposed in a storage cabinet. The cabinet includes an upright drawer supporting plate. The drawer assembly includes a drawer and a drawer locking device. The drawer locking device includes a retaining unit and a handle unit. The retaining unit includes a stop member connected fixedly to the drawer supporting plate, and a swing arm. An arm body of the swing arm has a hooked free end that is hooked onto the stop member so as to prevent forward movement of the drawer relative to the drawer supporting plate. The handle unit is operable to rotate and remove the hooked free end of the swing arm from the stop member.

### CROSS-REFERENCE TO RELATED APPLICATION

This application claims priority of Chinese Application No. 201320528150.0, filed on Aug. 27, 2013.

### BACKGROUND OF THE INVENTION

1. Field of the Invention

This invention relates to a drawer, and more particularly to a cabinet drawer assembly having a drawer locking device.

2. Description of the Related Art

A conventional storage cabinet includes a cabinet body and a plurality of drawers that can be pushed in or pulled out. Typically, each of the drawers can be pushed completely into the cabinet so that it is at a storage position. However, since no means is provided for retaining each of the drawers at the storage position, when the cabinet is transported or subjected to an earthquake, the drawers may move relative to the cabinet. If this occurs, one hand of a user may be clamped between the cabinet body and one of the drawers. Or, when a heavier article is placed into one of the drawers, the one drawer may be drop from the cabinet body. When the one drawer drops from the cabinet body, damage may be caused to a user or the article.

### SUMMARY OF THE INVENTION

The object of this invention is to provide a drawer assembly for a storage cabinet that includes a drawer locking device for locking a drawer in the cabinet so as to promote safety during use.

According to this invention, a drawer assembly is disposed in a storage cabinet. The cabinet includes an upright drawer supporting plate. The drawer assembly includes a drawer and a drawer locking device. The drawer locking device includes a retaining unit and a handle unit. The retaining unit includes a stop member connected fixedly to the drawer supporting plate, and a swing arm. An arm body of the swing arm has a hooked free end that is hooked onto the stop member so as to prevent forward movement of the drawer relative to the drawer supporting plate. The handle unit is operable to rotate and remove the hooked free end of the swing arm from the stop member.

Due to the presence of the drawer locking device, the drawer may be retained at a rear limit position, thereby promoting safety during use.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a partly exploded perspective view of a storage cabinet including the preferred embodiment of a drawer assembly according to this invention;

FIG. 2 is a perspective view of the preferred embodiment;

FIG. 3 is a fragmentary exploded perspective view of the preferred embodiment;

FIG. 4 is a sectional view taken along line IV-IV in FIG. 2, illustrating a swing arm and a handle unit;

FIG. 5 is a sectional view taken along line V-V in FIG. 2, illustrating that a resilient member is stretched;

FIG. 6 is a view similar to FIG. 4 but illustrating that a hooked free end of the swing arm is hooked onto a stop plate portion of a stop member;

FIG. 7 is a view similar to FIG. 6 but illustrating that the handle unit is operated to remove the hooked free end of the swing arm from the stop plate portion of the stop member;

FIG. 8 is a view similar to FIG. 5 but illustrating that the resilient member is compressed;

FIG. 9 is a view similar to FIG. 7 but illustrating how the drawer is pulled out; and

FIG. 10 is a view similar to FIG. 9 but illustrating how the drawer is pushed in.

### DETAILED DESCRIPTION OF THE PREFERRED EMBODIMENT

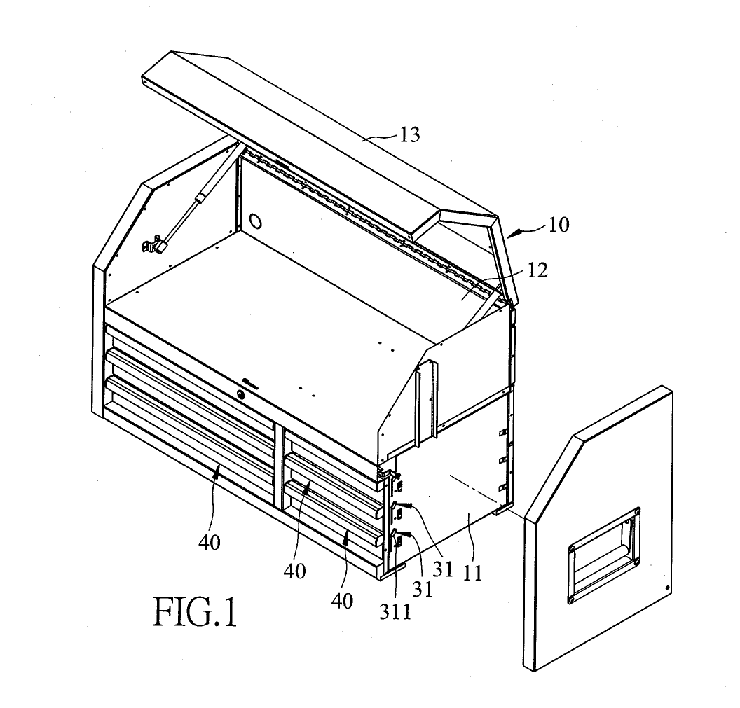

Referring to FIG. 1, the preferred embodiment of a drawer assembly according to this invention is adapted to be disposed in a storage cabinet 10. The storage cabinet 10 includes two upright drawer supporting plates 11 spaced apart from each other along a left-to-right direction, a rear plate 12 connected between rear ends of the drawer supporting plates 11, and a top cover 13 for covering top ends of the drawer supporting plates 11 and the rear plate 12.

The drawer assembly includes a drawer 20 disposed between the drawer supporting plates 11 and movable along a front-to-rear direction, and a drawer locking device including two retaining units 30 disposed between the drawer supporting plates 11 and mounted respectively on left and right sides of the drawer 20, and a handle unit 40 disposed on a front end of the drawer 20.

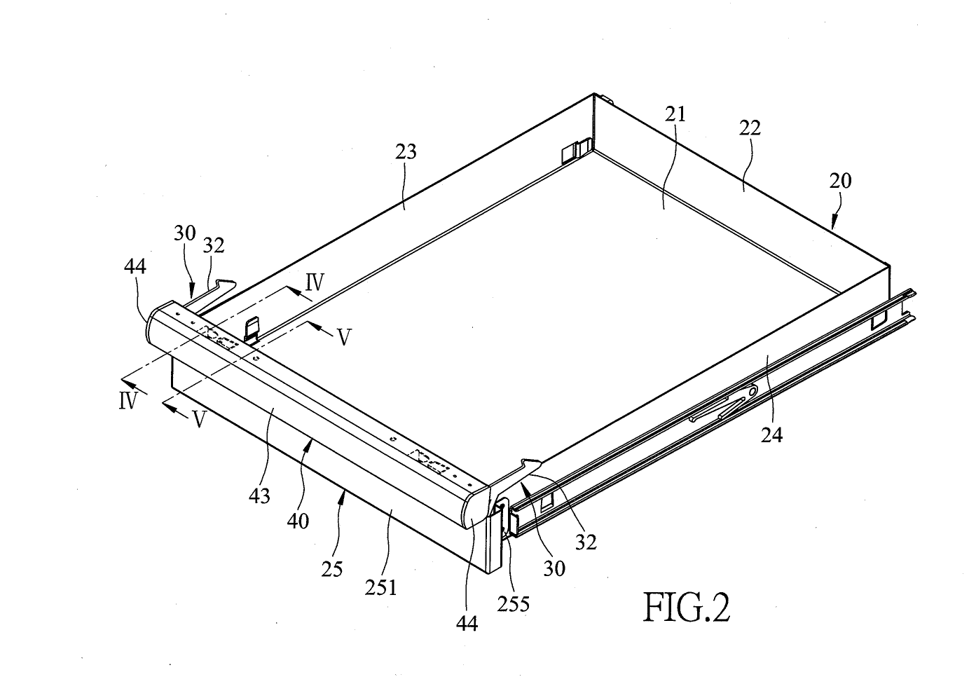

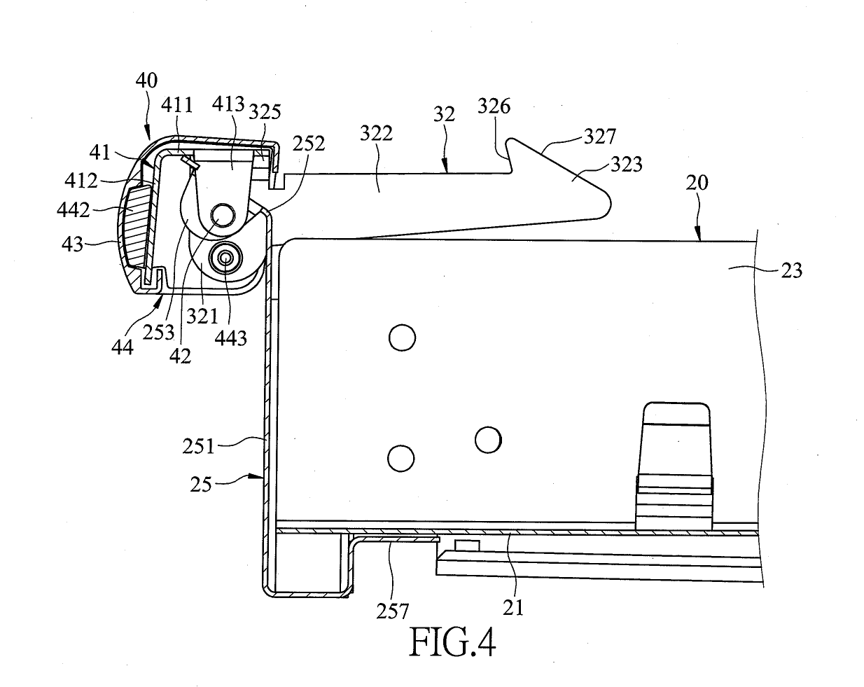

With further reference to FIGS. 2, 3, 4, and 5, the drawer 20 includes a bottom plate 21, an upright rear plate 22, an upright left plate 23, an upright right plate 24, and a front connecting piece 25. The left and right plates 23, 24 are connected respectively to left and right sides of the rear plate 22. The bottom plate 21 is connected to bottom ends of the rear, left, and right plates 22, 23, 24.

The front connecting piece 25 includes: an upright front plate 251 connected to front ends of the left and right plates 23, 24; a mounting plate 252 extending forwardly from a top end of the front plate 251 and having a width along a left-to-right direction, which is smaller than that of the front plate 251; a plurality of pivot lugs 253 extending from a bottom surface of the mounting plate 252; two openings 254 formed through the mounting plate 252; two bent lateral plates 255 bent respectively from left and right ends of the front plate 251 and connected respectively to the left and right plates 23, 24; two notches 256 formed respectively in left and right ends of the connecting pieces 25; and a bottom plate 257 bent rearwardly from a bottom end of the front plate 251 and connected fixedly to the bottom plate 21 of the drawer 20.

Preferably, an angle formed between the mounting plate 252 and the front plate 251 is greater than 90 degrees.

Each retaining unit 30 includes a stop member 31 connected fixedly to the corresponding drawer supporting plates 11, and a swing arm 32 disposed on the drawer 20 and abutting against the stop member 31 for preventing movement of the drawer 20 relative to the drawer supporting plates 11.

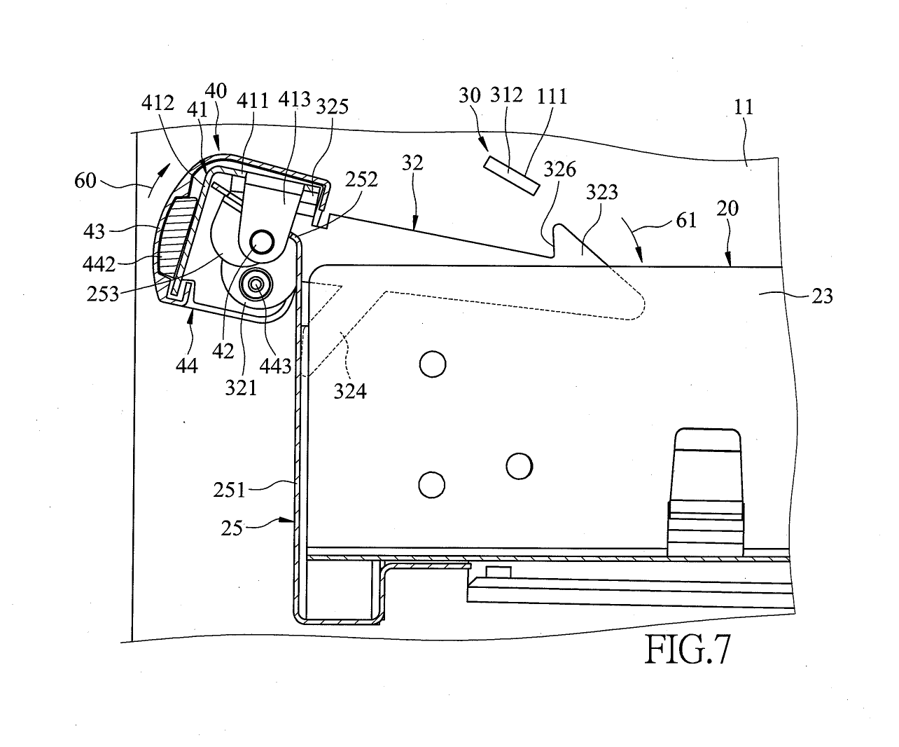

The stop member 31 of each retaining unit 30 is L-shaped, and has an abutment plate portion 311 abutting against the corresponding drawer supporting plate 11, and a stop plate portion 312 extending perpendicularly from an end of the abutment plate portion 311 and through a slot 111 (see FIG. 7) in the corresponding drawer supporting plate 11, such that the stop plate portion 312 forms an inclination angle of about 30-50 degrees with respect to a supporting surface (not shown) for supporting the cabinet 10.

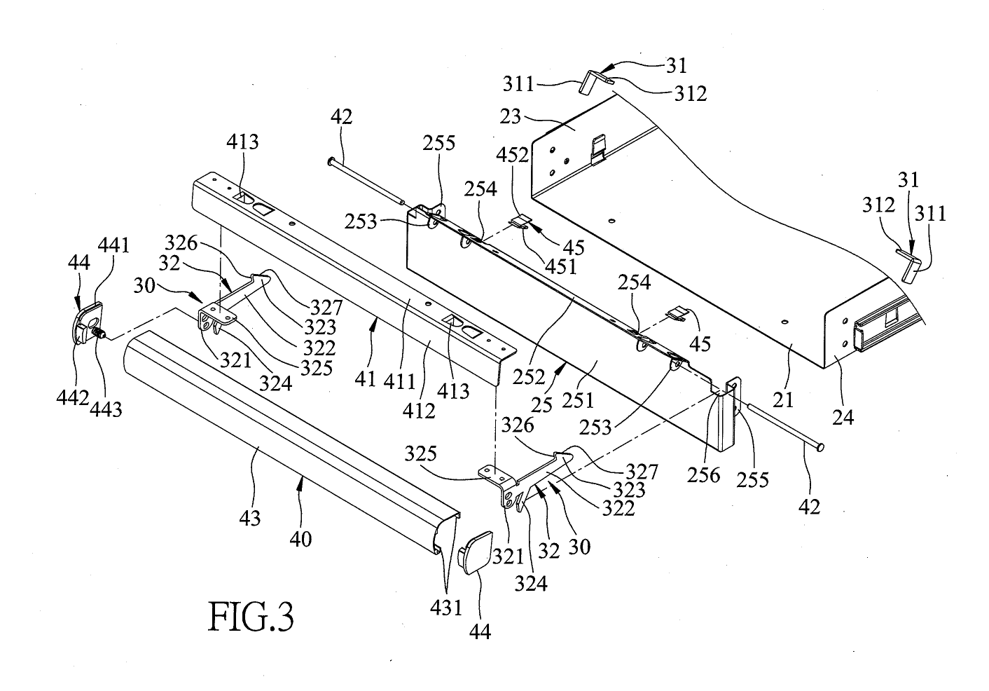

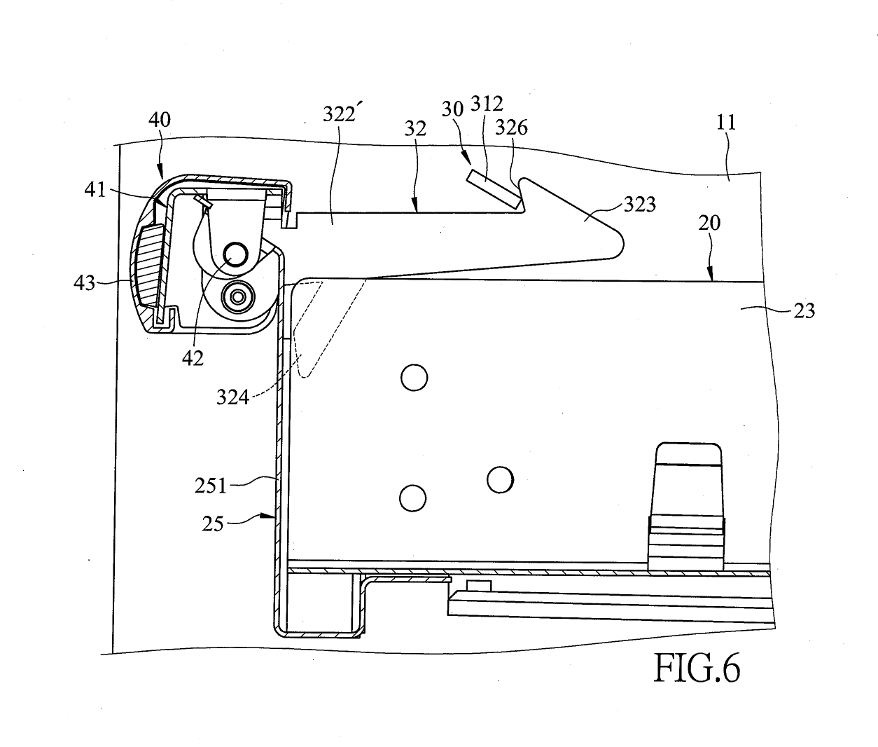

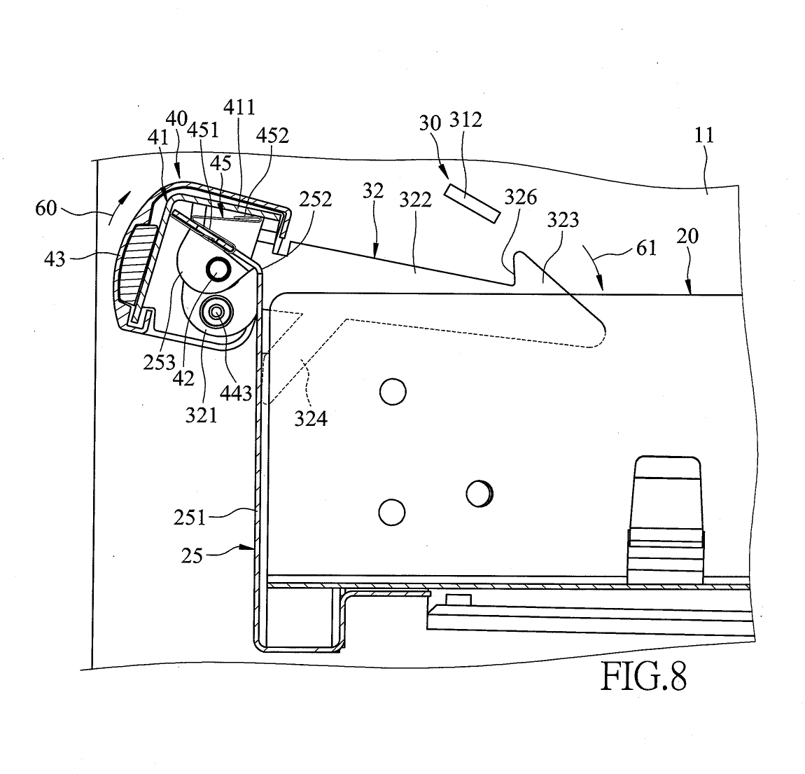

One retaining unit 30 will be described in this paragraph. The swing arm 32 has a pivot portion 321 (see FIG. 3) connected pivotally to one of the first pivot lugs 253, an arm body 322 extending rearwardly from the pivot portion 321 and through the corresponding notch 256 and having a hooked free end 323 that is hooked onto the stop member 31 so as to prevent forward movement of the drawer 20 relative to the drawer supporting plates 11, an ear plate 325 bent from a top end of the pivot portion 321 toward the one pivot lug 253. The arm body 322 further has an arm body 322′ (see FIG. 6) connected to and disposed in front of the hooked free end 323, and a stop block 324 extending from and disposed under the arm body 322′ and movable to contact a rear side surface of the front plate 25 for limiting the rotational angle of the swing arm 32. As such, the hooked free end 323 is pivotable between an engagement position shown in FIG. 6 and a lower limit position shown in FIGS. 7 and 8. The hooked free end 323 of the arm body 322 is configured as a barb, and has an abutment surface 326 abutting against and disposed behind the stop member 32, and an inclined guiding surface 327 extending downwardly and rearwardly from a top end of the abutment surface 326. When the hooked free end 323 is disposed at the engagement position (i.e., normal position), the inclined guiding surface 327 is parallel to the stop plate portion 312 of the stop member 31, as shown in FIG. 6.

The handle unit 40 includes an elongate connecting plate 41, two pivot pins 42, an elongate handle cover 43, two end covers 44, and two resilient members 45.

The connecting plate 41 is disposed above and adjacent to the mounting plate 252 of the drawer 20, extends along the left-to-right direction, and has a top plate portion 411 connected fixedly to the swing arms 32, a handle plate portion 412 extending downwardly from a front end of the handle plate portion 412, and two second pivot lugs 413 extending downwardly from an intermediate portion of the top plate portion 411. Each pivot pin 42 extends through the pivot portion 321 of the corresponding swing arm 32, the corresponding first pivot lug 253, and the corresponding second pivot lug 413, so that the top plate portion 411 is connected pivotally to the front connecting piece 25. As such, the handle plate portion 412 of the connecting plate 41 is operable to rotate the hooked free end 323 of each swing arm 32 relative to the drawer 20 between the engagement position and the lower limit position.

The handle cover 43 is sleeved on the connecting plate 41, and has open left and right ends, and two inwardly bent side edges 431 spaced apart from each other by a distance that is smaller than that between two side edges of the connecting plate 41 so as to prevent forward removal of the handle cover 43 from the connecting plate 41.

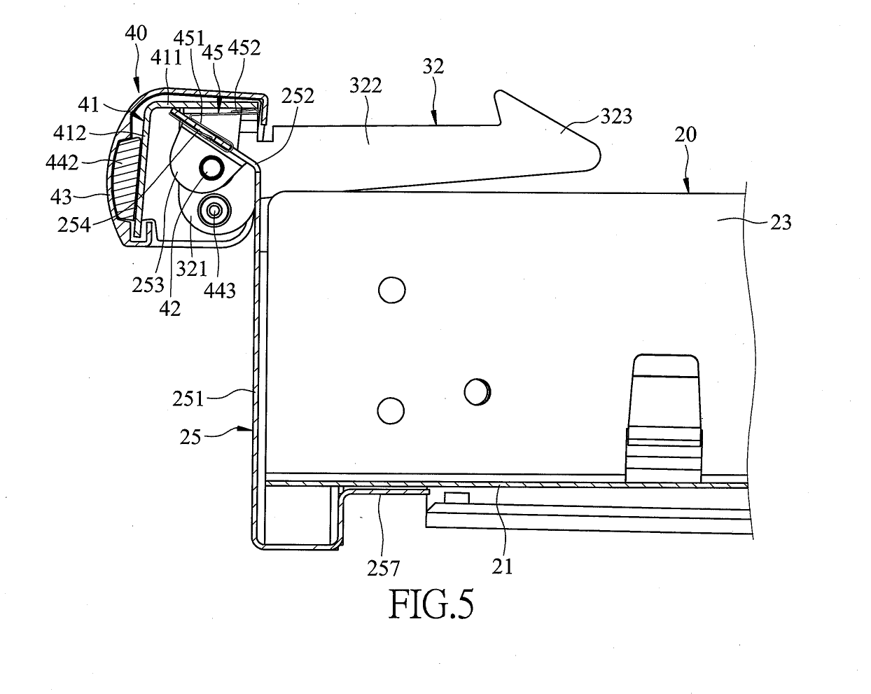

The end covers 44 are connected respectively and fixedly to the open left and right ends of the handle cover 43 such that removal of the connecting plate 41 from the handle cover 43 is prevented. Each end cover 44 includes a cover body 441, an insert block 442 extending from the cover body 441 and clamped between the handle cover 43 and the handle plate portion 412 of the connecting plate 41, and a pivot shaft 443 extending from the cover body 441 and through the swing arm 32. As such, the end covers 44 are connected respectively and fixedly to the swing arms 32. The end covers 44 cooperate with the connecting plate 41 and the handle cover 43 to constitute a rotating member. The rotating member is rotatable relative to the front connecting piece 25 to rotate and remove the hooked free ends 323 of the swing arms 32 from the stop members 31, thereby allowing for forward movement of the drawer 20 relative to the drawer supporting plates 11. The resilient members 45 (see FIGS. 5 and 8) are disposed between the mounting plate 252 of the front connecting piece 25 and the top plate portion 411 of the connecting plate 41 for biasing the top plate portion 411 away from the mounting plate 252 to rotate the hooked free end 323 of each swing arm 32 to the engagement position. In this embodiment, each resilient member 45 is configured as a generally V-shaped spring plate, and has a first plate portion 451 extending through the opening 254 (see FIG. 5) in the mounting plate 252 and clamping the mounting plate 252, and a second plate portion 452 that is connected to the first plate portion 452 to form an angle therebetween and that has a free end abutting against the top plate portion 411.

An angle formed between the mounting plate 252 and the front plate 251 is greater than 90 degrees. An angle formed between the mounting plate 252 and the top plate portion 411 is about 25-30 degrees. Due to the presence of the resilient members 45, the drawer 20 can be opened with relative ease.

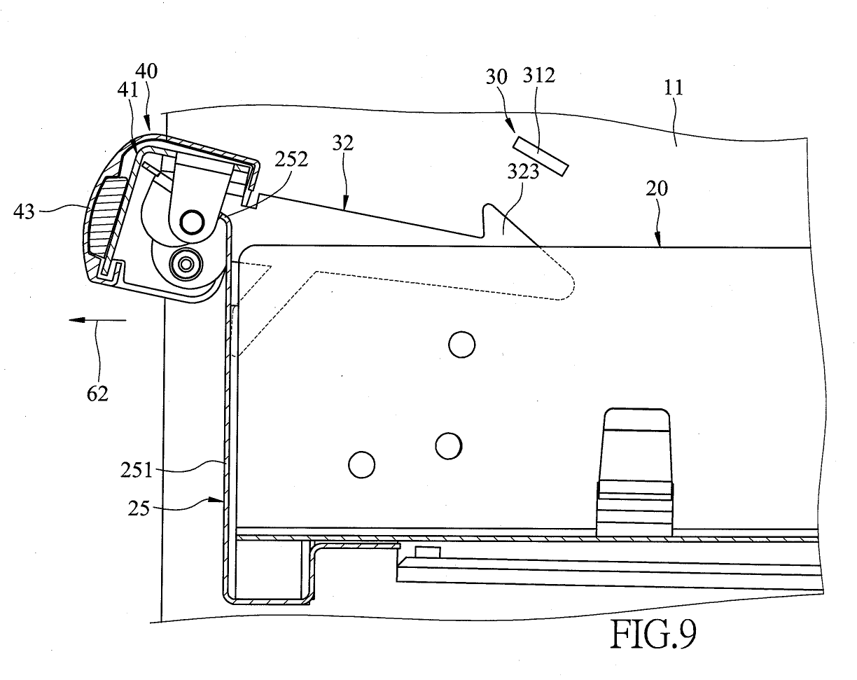

With particular reference to FIGS. 1 and 6, when the drawer 20 is pushed into the cabinet 10 to move to its rear limit position, the hooked free end 323 of each swing arm 32 is at the engagement position, so that movement of the drawer 20 in the cabinet 10 is prevented. With particular reference to FIGS. 7 and 8, when it is desired to open the drawer 20, bottom ends of the handle plate portion 412 of the connecting plate 41 and the handle cover 43 are first grabbed. Next, a force is applied to the handle plate portion 412 to rotate the connecting plate 41 in a clockwise direction 60 against the biasing action of the resilient members 45. At the same time, the handle cover 43, the end covers 44, and the swing arm 32 co-rotate with the handle plate portion 412 to thereby rotate the hooked free end 323 of each swing arm 32 until the stop blocks 324 of the swing arms 32 come into contact with the front plate 251 of the front connecting piece 25 (i.e., each hooked free end 323 is moved to the lower limit position). At this position, with further reference to FIG. 9, since the hooked free ends 323 are below the stop plate portions 312 of the stop members 31, the drawer 20 can be pulled out in a forward direction 62. Hence, the resilient members 45 are compressed to store a return force.

After the drawer 20 is pulled out to a desired position, the handle plate portion 412 and the handle cover 43 are released, so that the swing arms 32 are biased by the resilient members 45 to rotate counterclockwise until the hooked free ends 323 of the swing arms 32 come into contact with the stop plate portions 312 of the stop members 32 or rotate to their upper limit positions whereat the resilient members 45 are stretched completely. At this time, articles may be removed from or placed into the drawer 20.

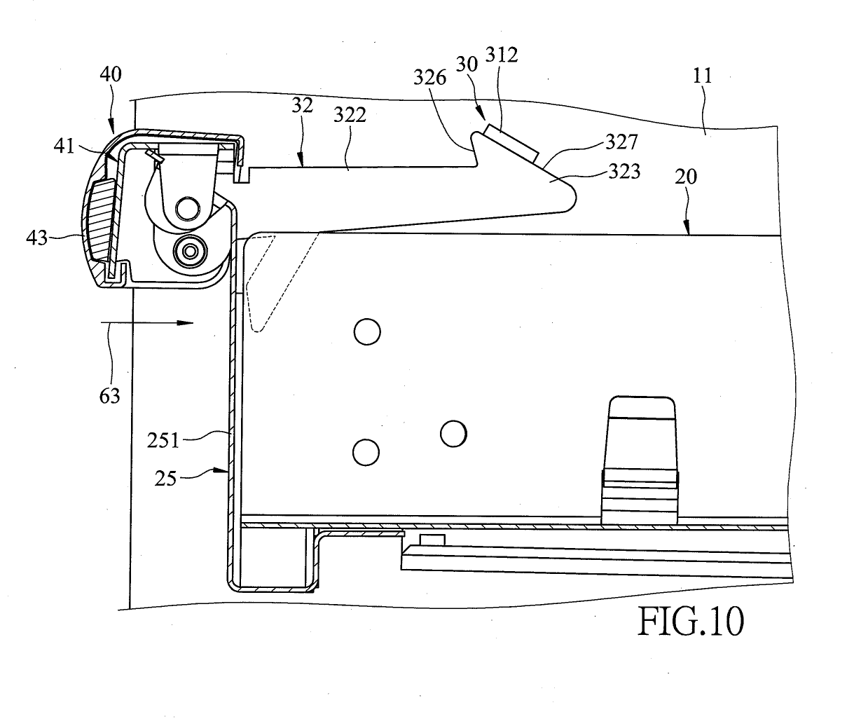

Subsequently, with further reference to FIG. 10, the drawer 20 can be pushed into the cabinet 10 in a rearward direction 63. During rearward movement of the drawer 20, the inclined guiding surfaces 327 of the hooked free ends 323 come into contact with the stop plate portions 312 of the stop members 32. Since the inclined guiding surfaces 327 are parallel to the stop plate portions 312, the hooked free ends 323 can move smoothly on the stop plate portions 312. As soon as the hooked free ends 323 pass past the stop plate portions 312 (i.e., the drawer 20 is moved to its rear limit position), due to the biasing action of the resilient members 45, they are rotated to the engagement positions.

In view of the above, the drawer assembly of this invention has the following advantages:

1. The drawer 20 can be locked releasably at the rear limit position in the cabinet 10 by the drawer locking device to promote safety during use.

2. The stop blocks 324 of the swing arms 32 are movable to contact the front plate 251 of the front connecting piece 25, thereby limiting the rotational angle of the swing arms 32 and the connecting plate 41.

3. Since the drawer 20 is maintained at the rear limit position by the biasing force of the resilient members 45, it can be removed easily from the rear limit position, thereby resulting in convenience during use.

4. The inclined guiding surfaces 327 are parallel to the stop plate portions 312, so as to facilitate smooth rearward movement of the drawer 20.

With this invention thus explained, it is apparent that numerous modifications and variations can be made without departing from the scope and spirit of this invention. It is therefore intended that this invention be limited only as indicated by the appended claims.

I claim:

1. A drawer assembly adapted to be disposed in a storage cabinet, the storage cabinet including two upright drawer supporting plates, said drawer assembly comprising:
a drawer including an upright rear plate having opposite left and right sides, an upright left plate connected to said left side of said rear plate, an upright right plate connected to said right side of said rear plate and spaced apart from said left plate in a left-to-right direction, a bottom plate connected to bottom ends of said rear, left, and right plates, and a front connecting piece, said front connecting piece including an upright front plate connected to front ends of said left and right plates, and a mounting plate extending forwardly from a top end of said front plate; and
a drawer locking device including:
at least one retaining unit adapted to be disposed between said drawer supporting plates and including a stop member adapted to be connected fixedly to one of the drawer supporting plates, and a swing arm having a pivot portion disposed pivotally on said mounting plate, and an arm body extending rearwardly from said pivot portion and having a hooked free end that is hooked onto said stop member so as to prevent forward movement of said drawer relative to said drawer supporting plates, and
a handle unit including a rotating member disposed pivotally on said front connecting piece of said drawer and connected to and co-rotatable with said swing arm, said rotating member being rotatable relative to said front connecting piece to rotate and remove said hooked free end of said swing arm from said stop member, thereby allowing for forward movement of said drawer relative to said drawer supporting plates.

2. The drawer assembly as claimed in claim 1, wherein said rotating member of said handle unit includes a connecting plate disposed above and adjacent to said mounting plate of said drawer, and said handle unit includes at least one resilient member disposed between said mounting plate and said connecting plate for biasing said hooked free end of said swing arm to engage said stop member.

3. The drawer assembly as claimed in claim 2, wherein said resilient member is configured as a generally V-shaped spring plate, and has two interconnected plate portions forming an angle therebetween, one of said plate portions being secured to said mounting plate, the other of said plate portions having a free end abutting against said connecting plate.

4. The drawer assembly as claimed in claim 2, wherein said rotating member of said handle unit includes:
an elongate connecting plate extending along the left-to-right direction and having a top plate portion connected pivotally to said front connecting piece, and a handle plate portion extending downwardly from said top plate portion;
an elongate handle cover sleeved on said connecting plate and having open left and right ends; and
two end covers connected respectively and fixedly to said open left and right ends of said handle cover such that removal of said connecting plate from said handle cover is prevented, said end covers being connected respectively to said swing arms, so that said handle plate portion of said connecting plate and said handle cover are operable to rotate said swing arms relative to said drawer.

5. The drawer assembly as claimed in claim 2, wherein:
said stop member of said retaining unit is L-shaped, and has an abutment plate portion adapted to abut against a corresponding one of the drawer supporting plates, and a stop plate portion extending perpendicularly from an end of said abutment plate portion and adapted to extend through the corresponding one of the drawer supporting plates; and
said hooked free end of said swing arm of said retaining unit is configured as a barb, and has an abutment surface abutting against and disposed behind said stop member of said retaining unit, and an inclined guiding surface extending downwardly and rearwardly from a top end of said abutment surface.

6. The drawer assembly as claimed in claim 5, wherein said stop plate portion of said stop member is parallel to said inclined guiding surface of said hooked free end of said swing arm.

7. The drawer assembly as claimed in claim 1, wherein said arm body of said swing arm further has an arm body connected to and disposed in front of said hooked free end, and a stop block extending from and disposed under said arm body and adapted to be movable to contact a rear side surface of said front plate of said front connecting piece of said drawer for limiting a rotational angle of said swing arm.
